(19) United States
(12) Patent Application Publication
(10) Pub. No.: US 2009/0301399 A1
(43) Pub. Date: Dec. 10, 2009

(54) FISH AND PLANT FACTORY

(75) Inventors: Terry L. Brown, Fayetteville, NY (US); George Mezey, Camillus, NY (US)

Correspondence Address: BOND, SCHOENECK & KING, PLLC, ONE LINCOLN CENTER, SYRACUSE, NY, 13202-1355, US

(73) Assignee: O'Brien & Gere Engineers, Inc, East Syracuse, NY (US)

(21) Appl. No.: 12/480,108

(22) Filed: Jun. 8, 2009

Related U.S. Application Data
(60) Provisional application No. 61/059,412, filed on Jun. 6, 2008.

(51) Int. Cl. A01K 61/00; A01G 31/02

(52) U.S. Cl. 119/226; 47/62 R; 47/1.4; 47/17

(57) ABSTRACT

The present invention relates to a combined interdependent fish and plant factory. An embodiment of the present invention includes a fish house connected to a greenhouse, a biofuel source, and a generator connected to the biofuel source and to at least one of the fish house and the greenhouse, where the generator is adapted to utilize biofuel as a fuel source and to provide electrical power to at least one of the fish house and the greenhouse. An embodiment can also include a waste heat recovery boiler or an algae reactor. Another embodiment includes a method for growing plants and farming fish in a combined interdependent fish and plant factory including a fish house connected to a greenhouse, including the steps of utilizing biofuel from a biofuel source to create electric power, and providing the electric power to at least one of the fish house and the greenhouse.

### RELATED APPLICATION

The present application claims priority to U.S. provisional patent application No. 61/059,412, filed on Jun. 6, 2008, which is hereby incorporated by reference herein in its entirety.

### BACKGROUND OF THE INVENTION

1. Field of Invention

The present invention relates generally to fish farms/factories and plant farms/factories, and, more particularly, to a combined interdependent fish and plant factory that creates sources of renewable energy, is powered by renewable energy, and utilizes waste heat and CO₂ generated by the combustion of the renewable energy for a variety of applications including heating and cooling the combined fish and plant factory and photosynthesis.

2. Description of Prior Art

Aquaculture is known as the controlled cultivation or farming of plants and animals that live in the water. Fish farming is a form of aquaculture where fish are raised in tanks for commercial food purposes. Hydroponics is another form of aquaculture where plants are grown on grow beds in a mineral nutrient rich solution instead of in soil.

Aquaponics is the combination of a fish farm with a hydroponic system within one closed controlled system. Water is circulated, or recycled, between the fish farm and the hydroponic greenhouse. Fish effluent such as fish waste (which is rich in plant nutrients, but would be toxic to the fish if it remained in the fish tanks) is transferred in the water out of the fish tanks of the fish farm and to the hydroponic greenhouse where the plants grow pursuant to their uptake of the nutrient rich fish effluent. Due to this uptake of nutrient rich fish effluent from the water, which would be toxic to the fish, clean water can then be transferred back to the fish tanks for the cycle to begin anew.

Power is required to continuously pump or circulate water from the fish tanks to the hydroponic system and back to the fish tank. Power is also required to heat and maintain the temperature of the fish and hydroponic systems, as well as run and maintain other aspects of the aquaponic system. Power or energy, in the form of electricity, has been noted as one of several major expenses which is needed to run a conventional fish farm and hydroponic network. See, e.g., U.S. Pat. No. 5,046,451 to Inslee et al, which is hereby incorporated by reference herein in its entirety.

Non-renewable energy sources include fossil fuels (coal, oil, natural gas), the combustion of which accounts for the majority of greenhouse gas emissions and other pollutants (e.g., NOx and SOx) in the United States. Generating units at power plants, for example, convert energy from these non-renewable energy sources to make electricity that is supplied to consumers, such as conventional fish farms with hydroponic systems.

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### SUMMARY OF THE INVENTION

The present inventions recognizes that there are potential problems and/or disadvantages in the above-discussed way of powering a fish farm and hydroponic network. One potential problem is the inevitable consumption of non-renewable fossil fuels. A related potential problem is the potential threat to the Earth's climate. Another problem is the high cost of energy to regulate temperatures inside the fish farm and hydroponic network. A related problem is that conventional fish farm and hydroponic networks do not utilize the waste heat from the production of the electricity that powers such networks. Various embodiments of the present invention may be advantageous in that they may solve or reduce one or more of the potential problems and/or disadvantages discussed above in this paragraph.

It is a principal object and advantage of the present invention to exploit renewable energy as opposed to fossil fuel sources in a combined fish and plant factory. Renewable energy is a term of art used to describe power derived from environmentally friendly sources of energy including renewable (or regenerative), non-polluting energy sources. (No source can be completely non-polluting, since any energy source requires an input of energy which creates some pollution.) Specific types of renewable energy include wind power, solar power, hydropower, geothermal power, and biomass/biofuel power. Biomass (or solid biofuel) is a type of renewable energy source that includes solid plant matter created by plants through photosynthesis, a process which uses the sun's energy (along with water and atmospheric carbon dioxide) to produce glucose and oxygen. Biomass also includes biodegradable wastes such as sludge, which is the part of sewage that remains after the contaminants have been removed. Biomass may be converted into another type of renewable energy source, liquid biofuel. Liquid biofuel includes unprocessed vegetable oil, biodiesel, ethanol (including E85—a blend of 85% ethanol and 15% gasoline), and virgin and recycled animal parts. Biodiesel is used as a substitute for petroleum diesel and can be produced from fish oil from fish waste products, unprocessed vegetable oil (e.g., straight vegetable oil or waste vegetable oil) or animal fat through the process of transesterification (a process which should be appreciated by those skilled in the art and need not be repeated in detail herein). Briefly, vegetable oils are made of triglycerides, and the triglycerides are reacted with an alcohol (e.g., methanol or ethanol) in the presence of a catalyst (e.g., a strong base such as potassium hydroxide) to form a monoalkyl ester (e.g., methyl ester or ethyl ester—the biodiesel) and glycerol. Types of biodiesel include B100 (100% pure biodiesel) and B20 (20% biodiesel and 80% petroleum diesel). Biodiesel is sometimes used as a source of renewable energy over straight or waste vegetable oil, because biodiesel is less viscous. The higher viscosity of the vegetable oils leads to problems such as incomplete combustion in a combustion engine. However, the processing of vegetable oil to make biodiesel requires an expenditure of chemical materials and energy, as outlined supra. Other than transesterfying unprocessed vegetable oil into biodiesel, the viscosity of the unprocessed vegetable oils may be reduced through the addition of heat. Biodiesel can also be formed from algae oil. Algae has recently been touted as a very promising biodiesel source for several reasons. First, there is less of a concern that consumers will be trading “food for fuel” as compared with other renewable energy sources made from oilseed crops such as corn and soybean. Second, algae has been shown to provides a higher yield of biodiesel per unit versus other oilseed crops. Third, algae can be grown in a wasteland, for example, thus lessening the harm done to farmlands due to overharvesting. Energy, in the form of stored chemical bond energy, from biomass or liquid biofuel is usually harvested through combustion and is used to create electricity and heat. Moreover, biomass and liquid biofuel are biodegradable and non-toxic. Combustion of biomass or liquid biofuel sends carbon (CO₂)—that was relatively recently converted by the plants from the atmosphere into glucose and is considered to be part of the carbon cycle—back into the atmosphere with substantially no net addition of carbon (i.e., “carbon neutral”) to the carbon cycle.

It is another object and advantage of the present invention to use renewable energy sources instead of non-renewable energy sources in a cogeneration system set-up to create the energy to run a combined fish farm and hydroponic network, which can decrease the expense in running such a system. Cogeneration (also known as combined heat and power) refers to the combined production and utilization of electricity and heat energy, where the heat energy would normally be wasted, from a common fuel source. This “waste heat” is typically created as a byproduct during an industrial process. Instead of releasing this heat into the surrounding environment (and essentially treating this heat energy as waste heat), a cogeneration system will harness this heat energy for further uses. Cogeneration systems allow for the use of a higher percentage of energy obtained from a fuel source. This translates into fuel source conservation, and thus savings to the user of the cogeneration system, since less of the fuel needs to be used to obtain the same amount of useful energy from the fuels source (as compared to a system that does not harness the waste heat). The efficiency of a cogeneration system increases when the heat that is obtained from a fuel source is utilized close to where the heat is created and harnessed. Further, the heat energy can be in the form of hot water or steam, for example.

It is a further object and advantage of the present invention to exploit such renewable energy in a cogeneration facility, where the renewable energy could be utilized to its fullest potential thereby using less fuel and passing off the savings to the user of such a facility.

It is another object and advantage of the present invention to provide a combined fish and plant factory that can operate almost anywhere (e.g., an open lot in a city or a field in the country), and can allow food to be grown close to customers, eliminate transportation costs, enhance food safety by growing food in a controlled environment, recycles wastes, and helps conserve resources such as soil, water and wild fish populations.

In accordance with an embodiment of the present invention, fish farms/factories and plant farms/factories, and, more particularly, a combined interdependent fish and plant factory that creates sources of renewable energy, is powered by renewable energy, and utilizes waste heat and CO₂ generated by the combustion of the renewable energy for a variety of applications including heating and cooling the combined fish and plant factory and photosynthesis, is provided. An embodiment of the present invention combines fish farming, hydroponic vegetable cultivation, and energy production.

In accordance with an embodiment of the present invention, a combined interdependent fish and plant factory comprising a fish house with a plurality of fish tanks adapted for containing water and fish therein, and a greenhouse with a plurality of hydroponic tanks adapted for containing plants in grow beds therein, within a multilevel housing unit, is provided. In accordance with a preferred embodiment of the present invention, a combined multilevel, soil-less, climate controlled, interdependent fish and plant factory, that produces fish, vegetables, heat and electricity is provided.

In accordance with a preferred embodiment of the present invention, the fish house portion of the overall structure of the combined interdependent fish and plant factory of an embodiment of the present invention is underneath the greenhouse and substantially below the ground. The fish house is preferably surrounded on three sides by a concrete slab foundation, and is preferably adapted for excluding sunlight and maintaining a relatively constant temperature for the fish tanks. The hydroponic tanks, in turn, are preferably housed in an adjacent greenhouse which forms the other portion of the overall structure of the combined interdependent fish and plant factory of an embodiment of the present invention. The greenhouse portion of the factory structure can share the ceiling of the fish house, which for the greenhouse acts as the floor. The remaining walls of the greenhouse may be constructed of conventional greenhouse transparent or translucent material, such as glass, plexiglass or plastic sheeting.

In accordance with a preferred embodiment of the present invention, the combined interdependent fish and plant factory of an embodiment of the present invention comprises a pipe system with a plurality of pipes that connects the hydroponic tanks of the greenhouse with the fish tanks of the fish house. This connection is for the purpose of circulating the fish tank water through the hydroponic tanks with the assistance of at least one pump. The combined interdependent fish and plant factory operates on a substantially constant body of water that is continuously circulated or recycled (as described supra) from the fish tanks through at least one filter (e.g., a biofilter for converting ammonia to nitrite and nitrite to nitrate) to the hydroponic tanks and back again. With the assistance of the at least one pump, fish effluent, such as nitrogenous wastes, are removed from the fish tanks and are provided to the plants in the grow beds in the hydroponic tanks. These nitrogenous wastes, as noted supra, act as constant source of nutrients for the plants, while the plants serve as a filter to recycle the water for the fish. The plants effectively maintain the fish water in a habitable condition by removing these wastes which are toxic to the fish. In essence, the water is reused, filtered and sterilized while the fish and plants are grown in a controlled environment.

In accordance with an embodiment of the present invention, the fish factory is adapted for growing any number of a wide variety of aquatic life referred to herein simply as fish. The plant factory is adapted for growing plant life, and most preferably plants which produce herbs, fruits and vegetables. In a preferred embodiment of the present invention, pesticides of any kind are not used on the plants. Thus, the plants and fish grown in accordance with the present invention may be able to be certified “organic,” provided that they meet other requirements of such certification (which should be appreciated by those skilled in the art and need not be repeated herein).

In accordance with an embodiment of the present invention, generators are provided that provide electrical power to the combined interdependent fish and plant factory of an embodiment of the present invention. These generators can run on natural gas, and any secondary fuel including any conventional liquid biofuel such as unprocessed vegetable oil or waste cooking oil (the secondary fuel may also be a fossil fuel). The biofuel may also comprise biodiesel wherein the biodiesel is processed from the vegetable or waste cooking oil, soy oil, algae oil, or fish waste. These generators that utilize the liquid biofuel source create renewable “green” energy (electric power), and provide the electric power to the combined interdependent fish and plant factory of an embodiment of the present invention for many purposes. These purposes include running the pumps to circulate the water from the fish tanks to the hydroponic tanks, and powering other devices including any lighting provided in the fish house as well as other operating units within the factory. This electric power can also be provided to a substation and to a power grid to power other facilities, such as a college campus, shopping mall, business park, county, city, or town, and the like.

In accordance with an embodiment of the present invention, the generators are connected to waste heat recovery boilers (in a combined heat and power set-up) which harness the waste heat from the generators and provide this waste heat energy in the form of steam and/or hot water to the combined interdependent fish and plant factory of an embodiment of the present invention for optimum growth/yield of the fish and plants within the factory (e.g., heat the fish tanks and heat and cool the greenhouse). This waste heat energy can also be provided in the form of steam and/or hot water to other facilities, such as a college campus, shopping mall, business park, county, city, or town, and the like. This combined heat and power set-up can increase the energy efficiency from about 35% (without the use of a combined heat and power set-up) to about 70-90%. Additionally, CO₂ created during the combustion of these fuels is also harnessed and provided to the combined interdependent fish and plant factory of an embodiment of the present invention for purposes such as photosynthesis and optimum plant growth/yield. This CO₂ enhances the atmosphere of the greenhouse where the plants capture the carbon generated in this process.

In accordance with an embodiment of the present invention, a biodiesel refinery, which converts vegetable oil, waste cooking oil, soy oil, algae oil, and/or fish waste and the like into biodiesel, is provided. This biodiesel is then provided to the generators as a source of fuel, as noted supra.

In accordance with an embodiment of the present invention, fish waste created by fish within the fish tanks of the fish house of an embodiment of the present invention can be provided to the biodiesel refinery for conversion into biodiesel to fuel the generators. Additionally, an algae reactor can be provided as part of the combined interdependent fish and plant factory of an embodiment of the present invention. This algae reactor can be placed in an adjacent location to the greenhouse, preferably on the same floor as the greenhouse above the fish tank. The algae reactor can utilize the waste heat energy in the form of steam and/or hot water from the waste heat boilers, as well as the CO₂ created during the combustion of the fuels, as described supra. The algae reactor creates algae oil, which like the fish waste created in the fish tanks, can be provided to the biodiesel refinery for conversion into biodiesel to fuel the generators. The algae could also be used as fish food for the fish in the fish tanks.

### BRIEF DESCRIPTION OF THE DRAWINGS

The present invention will be more fully understood and appreciated by reading the following Detailed Description in conjunction with the accompanying drawings, in which:

FIG. 1 is a schematic view that illustrates a combined interdependent fish and plant factory according to an embodiment of the present invention.

FIG. 2 is a schematic view that illustrates a combined interdependent fish and plant factory according to an embodiment of the present invention.

### DETAILED DESCRIPTION

Reference will now be made in detail to the present preferred embodiments of the invention, wherein like numerals refer to like components, examples of which are illustrated in the accompanying drawings.

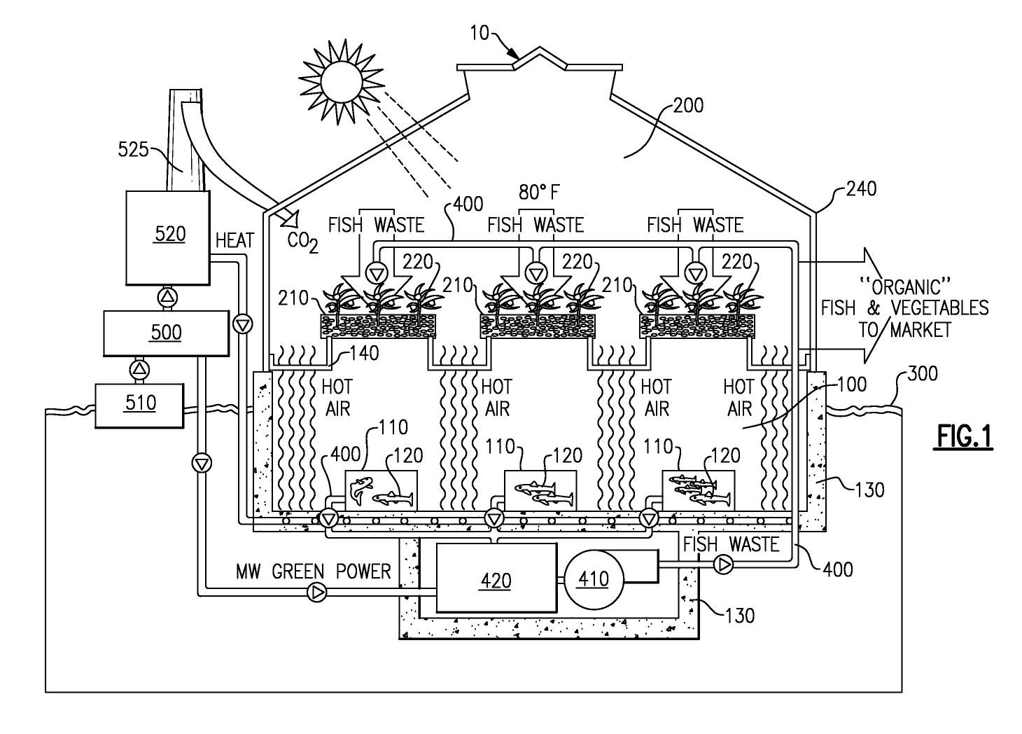

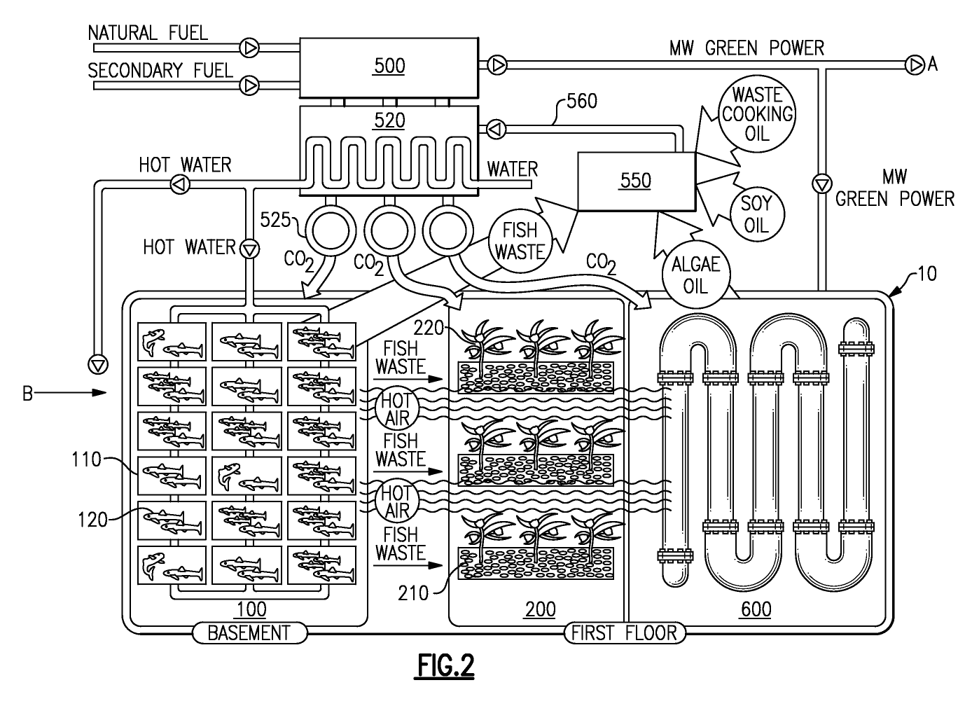

Turning to FIG. 1, a schematic view that illustrates a combined interdependent fish and plant factory 10 according to an embodiment of the present invention is shown. The combined interdependent fish and plant factory 10 comprises a fish house 100 with a plurality of fish tanks 110 adapted for containing water and fish 120 therein, and a greenhouse 200 with a plurality of hydroponic tanks 210 adapted for containing plants 220 in grow beds (not shown) therein, within a multilevel housing unit.

The fish house 100 is located underneath the greenhouse 200 and with the tanks 110 substantially below the ground 300. The fish house 100 is surrounded on three sides by a concrete slab foundation 130, and is preferably adapted for excluding sunlight and maintaining a relatively constant temperature for the fish tanks 110 (e.g., approximately 80-85° F.), and the air surrounding the fish tanks (e.g., approximately 85-90° F.).

The hydroponic tanks 210 are located in the greenhouse 200 which is positioned above the fish house 100. The separation boundary between the greenhouse 200 and the fish house 100 is surface 140 (which serves as the ceiling of the fish house 100 and the floor of the greenhouse 200). The remaining walls of the greenhouse 240 may be constructed of conventional greenhouse transparent or translucent material, such as glass, plexiglass or plastic sheeting.

A pipe system 400, which ultimately connect the hydroponic tanks 210 of the greenhouse 200 with the fish tanks 110 of the fish house 100 for the purpose of circulating the fish tank water with fish waste through the hydroponic tanks with the assistance of at least one pump 410, is also shown in FIG. 1. The fish tank water with the fish waste is pumped from the fish tanks through the pipe system 400, through at least one biofilter 420, and then to the hydroponic tanks 210 where the fish waste is removed from the water and utilized by the plants 220 as a source of nutrients. After the fish waste is removed, the water is circulated back to the fish tanks 110 where the cycle begins again. In the embodiment shown in FIG. 1, the biofilter 420 and the pump 410 are shown within an extension of the concrete slab foundation 130, which is underneath the fish house 100.

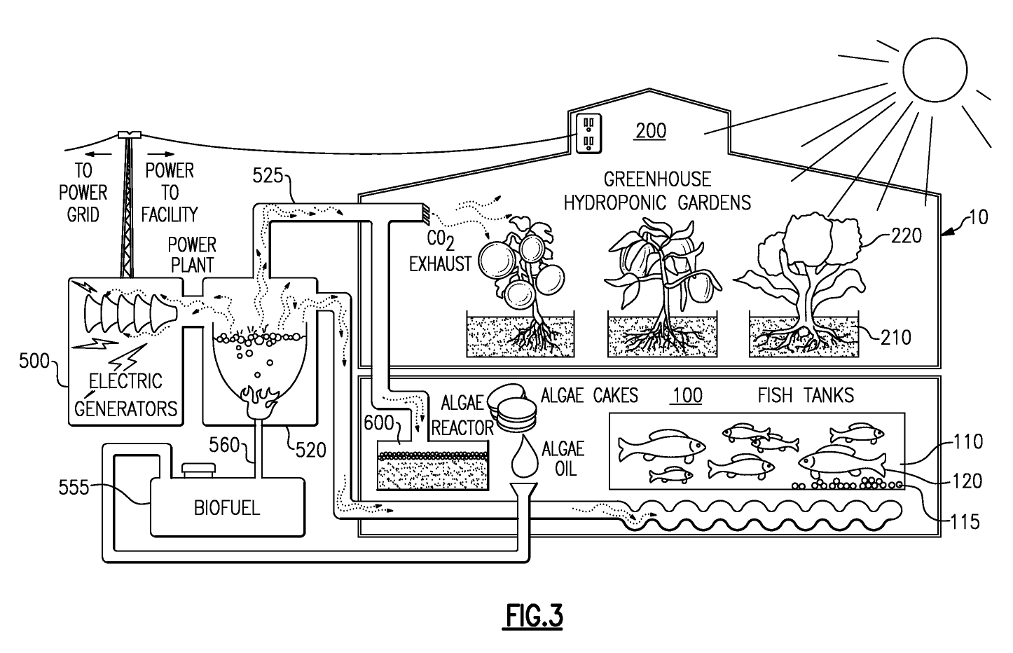

Generators 500 can run on natural gas and any secondary fuel (see FIG. 2) including any conventional liquid biofuel, as noted supra. As shown in FIG. 1, the generator 500 is connected to a source of biofuel 510 and a waste heat recovery boiler 520 with an exhaust stack 525. The generator 500 utilizes biofuel from the biofuel source to provide MW (e.g., 1.75) of electrical power (i.e., green power—power created from a renewable energy source) to the combined interdependent fish and plant factory 10 to, e.g., run the filter 420 and the pumps 410. The waste heat recovery boiler 520 which harnesses the waste heat from the generator 500, provides this waste heat energy in the form of steam and/or hot water to the combined interdependent fish and plant factory 10 for optimum growth/yield of the fish 120 and plants 220 within the factory 10. For example, the waste heat energy is provided to the floor of the concrete slab 130 of the fish house 100, as shown in FIG. 1. The heat energy, in the form of hot air, is shown rising from the floor of the concrete slab 130 of the fish house 100, through the fish house 100, and to the greenhouse 200. CO₂ created during the combustion of these biofuels is also harnessed from the exhaust stacks 525 and provided to the combined interdependent fish and plant factory 10 for purposes such as photosynthesis and optimum plant growth/yield.

Turning to FIG. 2, a schematic view that illustrates a combined interdependent fish and plant factory 10 according to an additional embodiment of the present invention is shown. Similarly to FIG. 1, FIG. 2 shows a combined interdependent fish and plant factory 10 which comprises a fish house 100 with a plurality of fish tanks 110 adapted for containing water and fish 120 therein, and a greenhouse 200 with a plurality of hydroponic tanks 210 adapted for containing plants 220 in grow beds (not shown) therein, within a multilevel housing unit. FIG. 2 also shows, however, an algae reactor 600, adjacent to the greenhouse 200 on the “first floor,” as part of the combined interdependent fish and plant factory 10.

A generator 500, which can run on natural gas and any secondary fuel, as described supra, is also shown in FIG. 2. The generator 500 is connected to a waste heat recovery boiler 520, which is connected to exhaust stacks 525. The generator 500 can provide MW (e.g., 1-2 MW) of electric (green) power to the combined interdependent fish and plant factory 10, as well as to a substation and a power grid to power other facilities A, such as a college campus, shopping mall, business park, county, city, or town and the like. The waste heat recovery boiler 520 provides waste heat energy in the form hot water/steam to the concrete slab 130 of the fish house 100. Waste heat energy in the form of hot air rises from the fish house in the “basement” to the greenhouse 200 and to the algae reactor 600. Waste heat energy in the form hot water/steam may also be provided to other facilities B, such as a college campus, shopping mall, business park, county, city, or town and the like.

A biodiesel refinery 550 (a biofuel source) is provided and is connected to a supplemental burner 560 for electric power production, which is also connected to the waste heat recovery boiler 520. This biodiesel refinery 550 can process biodiesel from sources such as vegetable or waste cooking oil, soy oil, algae oil, or fish waste, and the like (which can be used as a fuel source by the generator 500, as discussed supra). Algae oil from the algae reactor 600 may be provided as a source of biodiesel to the biodiesel refinery 550, and fish waste from the fish tanks 110 of the fish house 100 may also be provided as a source of biodiesel to the biodiesel refinery 550.

Turning to FIG. 3, a schematic view that illustrates a combined interdependent fish and plant factory 10 according to an additional embodiment of the present invention is shown. Similarly to FIGS. 1 and 2, FIG. 3 shows a combined interdependent fish and plant factory 10 which comprises a fish house 100 with fish tanks 110 adapted for containing water and fish 120 therein, and a greenhouse 200 with a plurality of hydroponic tanks 210 adapted for containing plants 220 in grow beds (not shown) therein, within a multilevel housing unit. FIG. 3 also shows an algae reactor 600 as part of the combined interdependent fish and plant factory 10.

A generator 500, which can run on natural gas and any secondary fuel (fuel made from plat or animal sources such as wood, or biodiesel made from fish guts or algae), is also shown in FIG. 3. The generator 500 is connected to a waste heat recovery boiler 520, which is connected to exhaust stacks 525. CO₂ emitted by the boiler through the exhaust stack 525 can enter the greenhouse 200 to enhance the growth of hydroponically grown vegetables (such as tomatoes, peppers, and/or broccoli), and can enter the algae reactor 600 to help grow algae. The generator 500 can provide electric (green) power to the combined interdependent fish and plant factory 10, as well as to a substation and a power grid to power other facilities, such as a college campus, shopping mall, business park, county, city, or town and the like. The waste heat recovery boiler 520 provides waste heat energy in the form hot water/steam to the fish house 100, greenhouse 200 and algae reactor 600. Waste heat energy in the form hot water/steam may also be provided to other facilities, such as a college campus, shopping mall, business park, county, city, or town and the like.

A biodiesel refinery 550 (a biofuel source) is provided and is connected to a supplemental burner 560 for electric power production, which is also connected to the waste heat recovery boiler 520. This biodiesel refinery 550 can process biodiesel from sources such as algae oil from the algae reactor 600, which can be used as a fuel by the reactor 500. Leftover algae cakes can be used as fish food for the fish 120 in the fish tanks 110.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the claimed invention.

What is claimed is:

1. A combined interdependent fish and plant factory comprising:
a. a fish house;
b. a greenhouse connected to said fish house;
c. a biofuel source; and
d. a generator connected to said biofuel source, and to at least one of said fish house and said greenhouse, wherein said generator is adapted to utilize biofuel as a fuel source and to provide electrical power to said at least one of said fish house and said greenhouse.

2. The combined interdependent fish and plant factory of claim 1, further comprising a waste heat recovery boiler connected to said generator and to at least one of said fish house and said greenhouse, wherein said waste heat recovery boiler is adapted to harness waste heat from said generator and provide waste heat energy to said at least one of said fish house and said greenhouse.

3. The combined interdependent fish and plant factory of claim 2, wherein said fish house further comprises a plurality of fish tanks structured to contain water and fish therein.

4. The combined interdependent fish and plant factory of claim 3, wherein said greenhouse further comprises a plurality of hydroponic tanks structured to contain plants in grow beds therein.

5. The combined interdependent fish and plant factory of claim 4, wherein the connection of said greenhouse to said fish house comprises a pipe system adapted to circulate water in said plurality of fish tanks through said plurality of hydroponic tanks and back to said plurality of said fish tanks.

6. The combined interdependent fish and plant factory of claim 4, wherein said waste heat recovery boiler is connected to said greenhouse and is adapted to harness CO₂ from combustion of the biofuel by the generator and provide the CO₂ to said plants in said greenhouse.

7. The combined interdependent fish and plant factory of claim 6, further comprising a biodiesel refinery adapted to process biodiesel from a biodiesel source selected from the group consisting of vegetable oil, waste cooking oil, soy oil, algae oil, and fish waste.

8. The combined interdependent fish and plant factory of claim 7, further comprising a supplemental burner connected to said biodiesel refinery, wherein said supplemental burner is adapted to produce electric power by utilizing the processed biodiesel as a fuel source.

9. The combined interdependent fish and plant factory of claim 8, further comprising an algae reactor adapted to grow algae and produce algae oil.

10. The combined interdependent fish and plant factory of claim 9, wherein said biodiesel source comprises algae oil produced by said algae reactor.

11. The combined interdependent fish and plant factory of claim 7, wherein said biodiesel source comprises fish waste produced by fish in said fish house.

12. The combined interdependent fish and plant factory of claim 9, wherein said supplemental burner is connected to said waste heat recovery boiler, and said waste heat recovery boiler is adapted to harness waste heat from said supplemental burner and provide waste heat energy to said at least one of said fish house, said greenhouse, and said algae reactor.

13. The combined interdependent fish and plant factory of claim 12, wherein said waste heat recovery boiler is connected to said algae reactor and is adapted to harness CO₂ from combustion of the processed bio diesel by the supplemental burner and provide the CO₂ to the algae in said algae reactor.

14. The combined interdependent fish and plant factory of claim 7, wherein said biofuel comprises biodiesel processed from said biodiesel refinery.

15. A combined interdependent fish and plant factory comprising:
a. a fish house;
b. a greenhouse connected to said fish house; and
c. an algae reactor adapted to grow algae and produce algae oil.

16. The combined interdependent fish and plant factory of claim 15, further comprising a biodiesel refinery adapted to process biodiesel from a biodiesel source selected from the group consisting of vegetable oil, waste cooking oil, soy oil, algae oil, and fish waste.

17. The combined interdependent fish and plant factory of claim 16, further comprising a supplemental burner connected to said biodiesel refinery, wherein said supplemental burner is adapted to produce electric power by utilizing the processed biodiesel as a fuel source.

18. The combined interdependent fish and plant factory of claim 17, wherein said biodiesel source comprises algae oil produced by said algae reactor.

19. The combined interdependent fish and plant factory of claim 18, further comprising a waste heat recovery boiler connected to said supplemental burner and to at least one of said fish house and said greenhouse and said algae reactor, wherein said waste heat recovery boiler is adapted to harness waste heat from said supplemental burner and provide waste heat energy to said at least one of said fish house, said greenhouse, and said algae reactor.

20. The combined interdependent fish and plant factory of claim 19, wherein said waste heat recovery boiler is adapted to harness CO₂ from combustion of the processed biodiesel by the supplemental burner and provide the CO₂ to at least one of the algae in said algae reactor and to said plants in said greenhouse.

21. A method for growing plants and farming fish in a combined interdependent fish and plant factory comprising a fish house and a green house connected to said fish house, comprising the steps of:
a. utilizing biofuel from a biofuel source to create electric power; and
b. providing the electric power to at least one of said fish house and said greenhouse.

22. The method of claim 21, further comprising the steps of:
a. harnessing waste heat from the utilization of the biofuel; and
b. providing waste heat energy to said at least one of said fish house and said greenhouse.

23. The method of claim 21, further comprising the step of circulating a substantially constant body of water between said fish house and said green house with the assistance of at least one pump, wherein said at least one pump is powered by the electric power.

24. The method of claim 21, further comprising the steps of:
a. harnessing CO₂ from the utilization of the biofuel; and
b. providing CO₂ to said greenhouse.
